(19) United States
(12) Patent Application Publication
(10) Pub. No.: US 2013/0064923 A1
(43) Pub. Date: Mar. 14, 2013

(54) Liquid Milk Beverage For Toddlers

(71) Applicants: Gabriel Remondetto, St-Hyacinthe (CA); Martine Surprenant, St-Alexandre (CA); Michel Pouliot, Marieville (CA)

(72) Inventors: Gabriel Remondetto, St-Hyacinthe (CA); Martine Surprenant, St-Alexandre (CA); Michel Pouliot, Marieville (CA)

(73) Assignee: Agropur Cooperative, Longueuil (CA)

(21) Appl. No.: 13/605,596

(22) Filed: Sep. 6, 2012

Related U.S. Application Data
(60) Provisional application No. 61/534,101, filed on Sep. 13, 2011.

(51) Int. Cl. A23C 9/158

(52) U.S. Cl. 426/2; 426/580; 426/72; 426/61; 426/71

(57) ABSTRACT

Described herein are a liquid milk beverage for toddlers comprising non-hydrolyzed, non-fermented and protein-rebalanced cow's milk, processes for making same and methods of uses. The non-hydrolyzed, non-fermented rebalanced cow's milk comprises a reduced weight/weight proportion of casein:whey proteins when compared to untreated cow's milk. The non-hydrolyzed, non-fermented rebalanced cow's milk may further comprises a reduced total protein concentration when compared to untreated cow's milk. The reduced proportion and/or reduced total concentration of proteins facilitate digestion of the liquid milk beverage by infant and toddlers. Also described are methods for providing nutrition to a toddler, methods for facilitating transition from breast feeding and/or artificial formula feeding of a child towards drinking of cow's homogenized milk, and methods for increasing digestion of cow's milk in an individual.

### REFERENCE TO RELATED APPLICATIONS

This application claims the benefit of and priority to U.S. Provisional Patent Application No. 61/534,101, filed Sep. 13, 2011, the complete disclosure of which is incorporated by reference herein.

### FIELD OF THE INVENTION

The invention relates to the field of nutrition and more particularly to liquid milk beverages.

### BACKGROUND OF THE INVENTION

An important change in nutritional habits occurs during the transition from infancy to toddlerhood at about one year of age. During this period of time, toddlers gain independence by developing self-feeding skills and increasing control over food choices. The transition is accompanied by improved motor skills, awareness of table behaviours, appreciation for tastes and preferences, and increased in energy and nutrient requirements. In fact, the 3 first years of a child are crucial for physical and psychological development. Furthermore, the immune system of children under 3 years old is not totally developed which leaves children under 3 years old more at risk of various infections. Thought, special care for alimentation must be taken for children under 3 years old.

It is well recognized that maternal milk is the premium nutritional source for newborn children. However, for different reasons, mothers often cease breastfeeding early in child development and switch to infant formulas, follow-up formulas and later on to natural cow's homogenized milk to provide essential nutrients to their children.

Artificial starter infant formulas are roughly based on a mother's milk composition at approximately one to three months postpartum. They are generally well balanced in nutrients but are often made from chemical rather than natural ingredients. Most commonly used infant formulas contains purified cow's milk whey and casein as protein source, a blend of vegetable oils as fat source, lactose as a carbohydrate source, a vitamin-mineral mix, and other ingredients depending on the manufacturer. In addition, often infant formulas are not well accepted by children because of their taste. Furthermore infant formulas are very expensive and are not convenient since they are often only available in a powder form, which requires manipulation. Examples of infant formulas that exist today include Good Start® (Nestlé), Enfamil™ (Mead Johnson), and Similac™ (Abbott).

Follow-up formulas are intended for children after the age of four to six months (weaning formulas) who have begun a diversified diet. These formulas are closer in composition to cow's milk than starter formula but they differ from cow's milk in the following: they are enriched with essential fatty acids, they have higher vitamin E content and they are fortified in iron and vitamin D. They are also supplemented with essential fatty acids, vitamins and trace elements, especially vitamin D and iron. Examples of follow-up formulas that exist include Nestle Junior™ (Nestlé), Milupa Croissance™ (Milupa), Guigoz Premier pas™ and Guigoz Confort™ (Laboratoire Guigoz), and Lemiel™ (Milupa).

Additional types of formulas include toddler's formulas which have been developed specifically to address diet concerns for child having about 10 to 36 months of age. These include Enfagrow® (Mead Johnson), Similac Go & Grow™ (Abbott), Follow-up® and NAN® H.A.3 (Nestlé), and the like. These formulas do not contain fresh cow's milk since they are typically in a powder form and they are made of non-fat or skim milk, skim milk powder, or enzymatically hydrolysed milk whey protein.

Natural liquid cow's milk is recognized as an important dietary component and it remains essential in the diet of most growing children, especially because of its high-quality proteins, its calcium and its vitamin A and D. It is also generally preferred by children over artificial formulas because it has a much richer enjoyable taste. However, liquid cow's milk comprises an elevated proportion of casein:whey proteins (about 80:20 weight/weight) and a too high total protein concentration compared to mother's milk, which renders it more difficult to digest, especially for infant and toddler. Natural liquid cow's milk is also poor in vitamin C, a vitamin known to be very important for absorption of iron in children. Because the milk industry is highly regulated in many countries (e.g. United States and Canada), natural liquid cow's milk cannot be easily modified to anyone desires since the final product has to remain entirely natural. Therefore, adding extraneous ingredients to milk for toddlers is not a trivial task.

There is therefore a need for a liquid milk beverage suitable for feeding toddlers of about 10 to 36 months of age. There is more particularly a need for a natural cow's milk liquid beverage having a reduced weight/weight proportion of casein:whey proteins compared to untreated cow's milk. There is also a need for a milk beverage and a method for increasing and/or facilitating digestion of cow's milk by toddlers (e.g. by reducing the proportion of casein:whey proteins).

There is further a need for a natural cow's milk liquid beverage having a reduced total protein concentration when compared to untreated cow's milk. There is also a need for a cow's milk liquid beverage comprising liquid cow's milk and externally added natural source of vitamin C, and more particularly cow's milk with vitamin C effective in enhancing iron absorption from other foods consumed by toddlers. There is also a need for a milk beverage and a method for facilitating transition from breast feeding and/or artificial formula feeding of a child towards drinking of cow's homogenized milk.

The present invention addresses these needs and other needs as it will be apparent from review of the disclosure, drawings and description of the features of the invention hereinafter.

### BRIEF SUMMARY OF THE INVENTION

The invention concerns a liquid milk beverage for toddlers comprising non-hydrolyzed, non-fermented and protein-rebalanced cow's milk. The non-hydrolyzed, non-fermented rebalanced cow's milk comprises a reduced weight/weight proportion of casein:whey proteins when compared to untreated cow's milk (i.e. raw or pasteurized, whole or skimmed bovine whole milk). In a preferred embodiment, the non-hydrolyzed, non-fermented rebalanced cow's milk further comprises a reduced total protein concentration when compared to untreated cow's milk. The reduced proportion and/or reduced total concentration of proteins facilitate digestion of the liquid milk beverage by infant and toddlers.

The invention also concerns a cow's milk liquid beverage for toddlers, comprising protein-rebalanced cow's milk having a reduced proportion of casein:whey proteins when compared to untreated cow's milk, wherein the reduced proportion of casein:whey proteins is not achieved by hydrolyzing or fermenting the cow's milk or its proteins.

In a preferred embodiment, the liquid cow's milk beverage, comprises:
fresh ultra-filtrated and Ultra High Temperature (UHT) pasteurized cow's milk, wherein the fresh ultra-filtrated cow's has been treated for having a weight/weight proportion of casein:whey proteins equal to or lower than about 50:50;
externally added algal oil; and
externally added juice of acerola berries.

The invention also concerns methods of uses, including a method for providing nutrition to a toddler, a method for facilitating transition from breast feeding and/or artificial formula feeding of a child towards drinking of cow's homogenized milk, and a method for increasing digestion of cow's milk in an individual.

Yet, the invention further concerns processes for making liquid and protein-rebalanced cow's milk having a reduced weight/weight proportion of casein:whey proteins when compared to untreated liquid cow's milk.

An advantage of the present invention is that it provides cow's milk liquid beverages for toddlers which are much more tasteful and less expensive to manufacture than existing artificial formulas. It also provides one hundred percent natural cow's milk liquid beverages reduced in casein for an easier digestion for toddlers and enriched in vitamin C in order to enhance iron absorption by toddlers. The beverage of the invention also provides a nutritionally balanced milk for toddlers and provides a transition milk beverage particularly useful between the transition period of breastfeeding or infant formula towards drinking of commonly commercially available homogenized cow's milk.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE FIGURES

In order that the invention may be readily understood, embodiments of the invention are illustrated by way of example in the accompanying drawings.

FIG. 1 is a flowchart showing a process for making liquid and protein-rebalanced cow's milk according to a first embodiment of the invention.

FIG. 2 is a flowchart showing a process for making liquid and protein-rebalanced cow's milk according to a second embodiment of the invention.

FIG. 3 is a flowchart showing a process for making liquid and protein-rebalanced cow's milk according to a third embodiment of the invention.

FIG. 4 is a flowchart showing a process for making liquid and protein-rebalanced cow's milk according to a forth embodiment of the invention.

FIG. 5 is a flowchart showing a process for making liquid and protein-rebalanced cow's milk according to a fifth embodiment of the invention.

Further details of the invention and its advantages will be apparent from the detailed description included below.

### DETAILED DESCRIPTION OF PREFERRED EMBODIMENTS

In the following description of the embodiments, references to the accompanying figures are by way of illustration of examples by which the invention may be practiced. It will be understood that other embodiments may be made without departing from the scope of the invention disclosed and claimed.

### Protein-Rebalanced Cow's Milk

Many milk formulas exist today for different age ranges (see Table 1 and Table 2). Initially, infant formulas were based on unmodified cow milk protein and therefore these formulas had a protein profile comprising 20% of whey and 80% casein. Human milk, compare to bovine milk, is a dynamic fluid changing from a high whey-casein ratio (almost 80% whey) to a 60:40 whey:casein ratio from colostrum to mature milk, respectively. In extended lactation this ratio is more of 50:50 whey:casein. Having a reduced proportion of casein is preferable because it results in a lower mineral concentration and therefore it lowers the renal solute load delivered to the infant (i.e. the sum of solutes excreted by the kidney, primarily consisting of dietary non-metabolizable components such as ingested electrolytes in excess of needs, and metabolic end products, predominately excess nitrogen).

One aspect of the invention relates to a cow's milk liquid beverage which is more acceptable for toddlers of about 10 to about 36 months of age because this beverage comprises protein-rebalanced cow's milk. The protein-rebalanced cow's milk comprises a reduced weight/weight proportion of casein:whey proteins when compared to untreated cow's milk (i.e. “natural” raw or pasteurized bovine whole or skimmed milk). In preferred embodiments, the liquid milk beverage of the invention further comprises a reduced total protein concentration when compared to untreated cow's milk. According to the invention, digestion by toddlers of the rebalanced cow's milk liquid milk beverage is facilitated because of the reduced weight/weight proportion of casein:whey. Indeed, the gastric discharge of whey proteins is faster than casein and that the texture of the stomach acid curd from a whey protein-rebalanced product is softer and more liquid than the curd produced from bovine milk. Reducing the casein content of protein in cow's milk (typically about 80% w/w) also move closer the liquid milk beverage of the invention to human breast milk (about 40% w/w casein). Furthermore, the Biological Value (BV) of whey proteins is higher than casein, providing a better balanced protein intake for covering the needs of the infant in essential amino acids.

Accordingly, in various embodiments the proportion of casein:whey proteins in the liquid milk beverage of the invention is equal to or lower than about 70:30, or equal to or lower than about 60:40; or equal to or lower than about 55:45, or equal to or lower than about 50:50, or equal to or lower than about 45:55, or equal to or lower than about 40:60 (i.e. 40% w/w casein and 60% w/w whey proteins).

Accordingly, in various embodiments the reduced total protein concentration when compared to untreated cow's milk equal to or lower than about 3.0% w/w or equal to or lower than about 2.6% w/w, or equal to or lower than about 2.2% w/w.

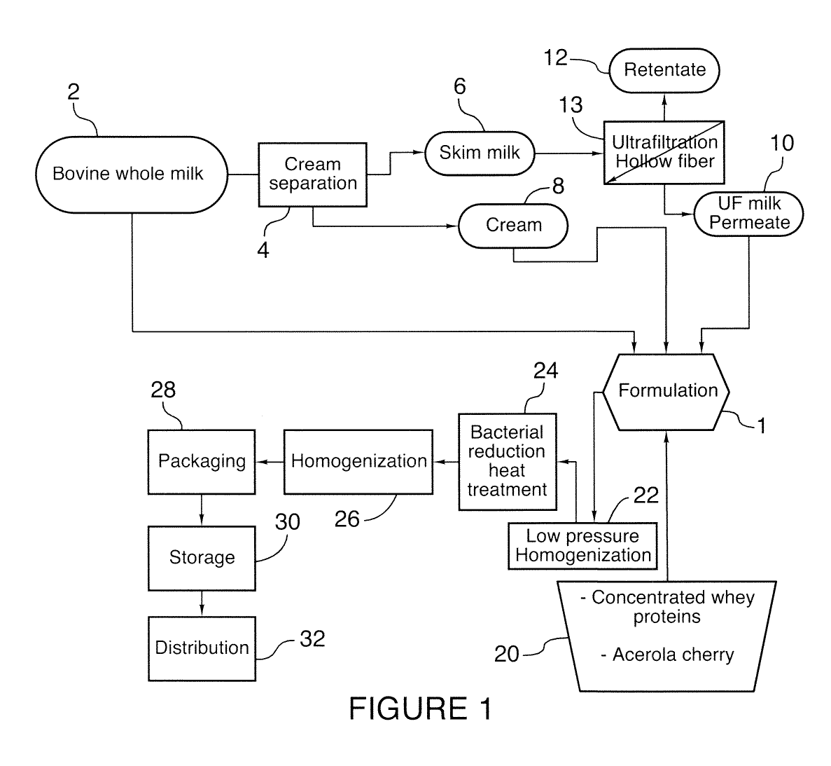

As described hereinafter, contrary to what is known in other formulas, the reduced proportion of casein:whey proteins is not achieved by hydrolyzing or by fermenting the cow's milk. Instead the reduced proportion of casein:whey proteins is obtained by mixing liquid cow's milk (fresh or pasteurized, whole or skimmed) with water, cream, whey protein concentrates (WPC), whey ingredients and/or milk permeate (e.g. milk ultrafiltration permeate) and/or modified milk ingredients. These ingredients are mixed in suitable quantities to obtain a protein-rebalanced cow's milk comprising a desired mineral, lipid and water content and also to obtain a desired weight/weight proportion of casein:whey proteins. Accordingly, in preferred embodiments the liquid milk beverage of the invention is entirely natural and it does not comprise hydrolyzed or fermented proteins. The Exemplification section and FIGS. 1-5 provides a few non-limitative examples of possible processes for making liquid and protein-rebalanced cow's milk according to various embodiments of the invention.

In preferred embodiments, the protein-rebalanced cow's milk origins from fresh cow's milk which has been collected, skimmed, ultra-filtrated or heat treated. Thereafter, the ultra-filtered milk is mixed with the other ingredients to rebalance its protein concentration and proportion, as described herein.

Preferably, the liquid milk beverage comprising the protein-rebalanced cow's milk is pasteurized before commercialization. Various known pasteurization process are acceptable and known to those skilled in the art. More preferably, the liquid milk beverage of the invention is pasteurized with a Ultra High Temperature (UHT) process (direct or indirect) or by using a High Temperature Short Time Sterilization (HTST) process. The UHT process allows a complete microbial destruction with a minimum loss in nutrients, more especially minimum loss of vitamin C and sulfurous amino acids. Given that the product is aseptically packaged after UHT, its shelf life can be of a few months at room temperature.

The liquid milk beverage of the invention may comprise additional ingredients to increase further its beneficial properties for toddlers. For instance, the liquid milk beverage may further comprises externally added ingredients including, but not limited to, vitamin(s) (e.g. vitamin A, provitamin A, vitamin C, vitamin D, vitamin D2, vitamin D3, vitamin E, Folic acid, etc.), prebiotic(s) (e.g. linulin, fructo-oligosaccharides (FOS), galacto-oligosaccharides (GOS), etc), probiotic(s) (e.g. Bifidobacterium bifidum BB-12, Bifidobacterium sp, Lactobacillus acidophilus, Lactobacillus casei, Lactobacillus reuteri), fiber(s) (e.g. inulin, polydextrose, pectine, etc), mineral(s) (e.g. calcium, iron, zinc, etc.), oils and lipids (e.g. algal oil, fish oil, marine oil, vegetable oil, etc.), selected essential fatty acid(s)s such as omega-3 (e.g. Docosahexaenoic acid (DHA), Eicosapentaenoic acid (EPA), Conjugated Linoleic acid (CLA), etc.), antioxidant(s) (e.g. green tea extracts, polyphenols, etc.), biologically active peptides, and other nutraceutical(s) and combinations thereof.

As it will be described herein after, the liquid milk beverage of invention preferably comprises externally added vitamin C, and more preferably vitamin C from a natural source such as acerola berries juice. In selected embodiments the cow's milk liquid beverage comprises about 0.5 mg/100 ml to about 4 mg/100 ml vitamin C, or about 1 mg/100 ml to about 4 mg/100 ml vitamin C, or about 2 mg/ml vitamin C.

Preferably, the liquid milk beverage of invention also comprises essential fatty acids including, but not limited to, omega-3, omega-6, conjugaged linoic acid (CLA). A preferred source of omega-3 is Docosahexaenoic acid (DHA). The essential fatty acids may be provided by different types of natural oil including, but not limited to, algal oil, fish oil or other edible marine oil. For instance, the liquid milk beverage may comprises about 0.01% w/w to about 0.25% w/w natural oil, or about 0.025% w/w to about 0.1% of natural oil. According to some embodiments, the liquid milk beverage may comprises about 0.01% w/w to about 0.25% w/w algal oil, or about 0.025% w/w to about 0.1% algal oil. In a preferred embodiment, the liquid milk beverage may comprises about 0.025% w/w algal oil and that natural oil provides a final concentration of about 100 mg/l Docosahexaenoic acid (DHA) in the liquid milk beverage. An example of a suitable algal oil according to the invention is the oil concentrated in DHA commercialized by Martek Biosciences Corp. (Columbia, Md.).

### Method of Making

A related aspect of the invention concerns a process for making liquid and protein-rebalanced cow's milk having a reduced weight/weight proportion of casein:whey proteins when compared to untreated liquid cow's milk (e.g. proportion of casein:whey proteins lower than 70:30, or lower than 60:40, or lower than 55:45 or lower than 50:50). Preferably, whole raw liquid cow's milk is used as the starting material and it is the standard used for comparing the reduced weight/weight proportion of casein:whey proteins according to the various embodiments of the invention. However, those skilled in the art will appreciate that other types of milk such as pasteurized or skimmed milk can also be used. Whole raw liquid cow's milk is also the preferred milk used as the standard for comparing the reduced weight/weight proportion of casein:whey proteins according to the various embodiments of the invention.

In one embodiment, the process comprises mixing, in suitable quantities, a milk permeate, cream and raw or pasteurized liquid cow's milk in order to obtain a liquid and protein-rebalanced cow's milk having a desired reduced weight/weight proportion of casein:whey proteins (e.g. proportion of casein:whey proteins equal to or lower than about 70:30, or equal to or lower than about 60:40, or equal to or lower than about 55:45 or equal to or lower than about 50:50). Preferably, the mixing of the suitable quantities is such that a desired lipid, mineral and water content is obtained as well. In another embodiment, the process comprises mixing in suitable quantities liquid cow's milk with water, cream, whey protein concentrates (WPC) (powder or liquid), whey and/or milk ultrafiltration permeate. In additional embodiments, the process comprises further mixing in suitable quantities vitamin C (e.g. acerola cherry extract in liquid (e.g. juice) or powder form). The Exemplification section and FIGS. 1-5 provides the steps of selected non-limitative examples of processes envisioned for making liquid and protein-rebalanced cow's milk according to various embodiments of the invention.

In particular embodiments, the method further comprises agitation, one or more steps of homogenization, a preheating step for protein stabilization, a step of pasteurization and a packaging step.

In a particular embodiment, the process comprises the steps of:
a) mixing sequentially the following ingredients according to the following proportions:

| | Desirable | Preferred |
|---|---|---|
| | proportions | proportions |
| INGREDIENTS | (% w/w) | (% w/w) |
| Cow's milk (3.25% w/w fat) | 25.00-35.00 | 30.30 |
| Cream (35% w/w fat) | 7.000-10.000 | 8.430 |
| WPC (80% w/w) | 0.500-1.500 | 0.870 |
| milk ultrafiltration permeate | 55.00-65.00 | 60.31 |
| Algal oil ** | 0.050-0.025 | 0.025 |
| Acerola *** | 0.020-0.200 | 0.040 |

* facultative but preferred ingredients as source of omega-3;
** facultative but preferred ingredients as source of vitamin C.

b) agitation, preferably for about 30 min up to 60 min at 4° C.;
c) homogenization of the ingredients (preferably multi-steps between 40° and 75°);
d) heating of the homogenized mixture between 60° C. and 90° C. for about 1 min in order to stabilize the proteins; and
e) pasteurization, preferably by using a Ultra High Temperature (UHT) process (e.g. about 130-150° C. for 2 to 10 sec, preferably about 138° C. for 4 sec) in direct or indirect mode.

Next, the pasteurized milk is packaged in any suitable container, preferably in an aseptic container such as Tetra Brik™. Aseptic packaging is generally preferable since it provides an extended shelf-life and the possibility of storage at room temperature. However, may other types of packaging known to those skilled in the art may be suitable (e.g. monolayer or multilayer plastic jugs or bottles, gable top cardboard, polyethylene pouch, etc.).

Examples 1 to 5 hereinafter provide additional exemplary processes according to the invention.

### Cow's Milk Enriched in Vitamin C

As it is known, Vitamin C is an essential micronutrient required for normal metabolic functioning of the body. The chief biological function of vitamin C is as a water-soluble antioxidant. Reduction of iron by vitamin C has also been implicated in enhanced gastrointestinal absorption of dietary non-haem iron. At high enough concentration, vitamin C can overcome the inhibitory effect of phytic acid in cereals toward the chelation of some minerals including iron. Other proposed activities include maintenance of enzyme thiols in a reduced state and sparing of glutathione. Finally, vitamin C has been implicated in strengthening of the immune system, something which is particularly important for children.

There is increasing evidence that deficiencies of micronutrients, such as vitamin C, adversely affect the physical and mental growth of children. Vitamin C supports growth via its role in collagen synthesis and, hence, the development of bone and soft tissues, and also indirectly by improving absorption of non-haem-iron, combating anaemia, another factor that negatively affects physical growth.

Because the milk industry is highly regulated in many countries (both the source and the list of possible ingredients which can be added are controlled), cow's milk with vitamin C has not been commercialized yet. Indeed, most of available vitamin C is chemically synthesized and most countries do not authorize addition of chemically synthesized products to liquid milk. The present inventors have found acceptable natural source of vitamin C for supplementing milk, and more particularly acceptable source of vitamin C which can be incorporated into a cow's milk liquid beverage for toddlers.

Accordingly, an additional aspect of the invention relates to a cow's milk liquid beverage for infant, toddlers or adults comprising cow's milk and externally added vitamin C. Preferably, the externally added vitamin C is from a natural source. In preferred embodiments, the cow's milk liquid beverage with vitamin C is a cow's milk liquid beverage for toddlers and the externally added vitamin C is present in an amount enhancing iron absorption from other foods consumed by toddlers. In embodiments, the cow's milk liquid beverage comprises about 0.5 mg/100 ml to about 4 mg/100 ml vitamin C, or about 1 mg/100 ml to about 4 mg/100 ml vitamin C, or about 2 mg/ml vitamin C.

In preferred embodiments, the natural source for the externally added vitamin C is a plant extract (e.g. fruit juice (i.e. liquid), or powder concentrate). More preferably, the cow's milk liquid beverage of the invention comprises acerola berries juice as a natural source for the externally added vitamin C.

Acerola berries (Malphigia emarginata) are particularly known for their high vitamin C content: 1 000 mg to 4 500 mg of vitamin C per 100 g of fruit, which is up to 90 times the vitamin C content of oranges. The concentration of Vitamin C in acerola berries is among the highest one can find in a berry grown on a commercial basis. For maximal vitamin C concentration, the berries have to be harvested just before the optimal maturity of the fruit and transformed very rapidly into a juice or powder. Acerola has very high antioxidant potency with a Trolox equivalent antioxidant activity of 53.2 mmol/g. In addition, acerola berries have been demonstrated to be a good source of provitamin A due to their content in carotenoids which is an important hormone-like growth factor for epithelial and other cells. Although acerola juice has been used in various drinks, including baby food, juices and alcohol (Wikipedia), it has never been used in combination with milk. As used herein, the term “acerola berry” or “acerola berries” refers to fruit of the tree Malpighia emarginata or Malpighia glabra also known as Barbados Cherry, West Indian Cherry and Wild Crapemyrtle.

Other possible sources of natural vitamin C may include camu camu (Myrciaria dubia), kakadu plum (Terminalia ferdinandiana), Rosehip (Rosa pomifera; cv Karpatia), Rosehip (Rosa sp; cv. Vitaminnyj). Other potential but less preferred sources include guava, papaya, strawberries, kiwi, cantaloupe, orange and grapefruit.

### Nutritional Applications

As described herein, the liquid milk beverages of the invention possess numerous advantages and thus find many beneficial applications.

Accordingly, an additional aspect of the invention concerns a method for providing nutrition to a toddler of about 10 to about 36 months of age, comprising feeding the toddler with a liquid milk beverage as defined herein.

Another aspect of the invention concerns a method for facilitating transition from breast feeding and/or artificial formula feeding of a child towards drinking of cow's homogenized milk, comprising: (i) providing a liquid milk beverage as defined herein; and (ii) incorporating to the child's diet increasing quantity of the liquid milk beverage. In particular embodiments, the method further comprises incorporating to the child's diet increasing quantity of cow's homogenized milk. Advantageously, the liquid milk beverage is mixed gradually with cereals, which may enhance absorption of the iron's cereal by the child.

Another related aspect of the invention concerns a method for increasing digestion of cow's milk in an individual, comprising: (1) rebalancing the protein content of raw or pasteurized liquid cow's milk to provide liquid rebalanced cow's milk having a reduced proportion of casein:whey proteins when compared to untreated “natural” liquid cow's milk; and (2) feeding the individual with the liquid non-hydrolyzed, non-fermented rebalanced cow's milk. Contrary to other artificial infant formulas where the proportion of milk proteins has been modified, the reduced weight/weight proportion of casein:whey proteins in the beverage of the invention is not achieved by hydrolyzing or fermenting the cow's milk. In various embodiments, the proportion of casein:whey proteins is equal to or lower than about 70:30, or equal to or lower than about 60:40, or equal to or lower than about 55:45 or equal to or lower than about 50:50.

### Additional Uses

Those skilled in the art will appreciate the benefits of the milk beverage according to the invention and may readily identify additional uses. For instance the milk beverage according to the invention may be beneficial to elderly, people suffering from allergies or intolerance to milk proteins or for the prevention and/or treatment of various diseases or conditions associated with a lack of vitamin D, vitamin C, and/or omega-3 fatty acids.

### Vitamin D

Various studies suggest that poor vitamin D intake or status is associated with an increased risk of colon, breast and prostate cancer. Since milk is naturally rich (or may be enriched) in vitamin D, the milk beverage according to the invention may thus find useful applications in the prevention and/or treatment of these cancers and other cancers.

It also been suggested that Vitamin D is a prevention factor for a number of autoimmune diseases, including psoriasis. Results from epidemiological studies and evidence from animal models suggest that the risk of autoimmune diseases (e.g. multiple sclerosis, insulin-dependent diabetes mellitus, rheumatoid arthritis) may be decreased by adequate vitamin D intake. Therefore, the milk beverage according to the invention comprising natural or added vitamin D may thus helpful for the prevention and/or treatment of immune mediated diseases.

Vitamin D plays also an important role in the prevention of osteoporosis and vitamin D insufficiency can be an important contributing factor in this disease. Therefore, drinking the milk beverage according to the invention may slow bone density losses and may decrease the risks of osteoporotic fracture in men and women.

### Vitamin C

Dozens of prospective studies suggest that vitamin C plays a role in preventing a variety of diseases, including but not limited to cardiovascular diseases (CVD) (e.g. heart disease and stroke). Vitamin C may protect coronary arteries by reducing the build-up of plaque by preventing the oxidation of LDL cholesterol (the “bad” cholesterol) and/or by boosting blood levels of HDL cholesterol (the “good” cholesterol). Therefore, drinking a milk beverage comprising externally added vitamin C according to the invention may have beneficial effects in the prevention and/or treatment of CVD and on blood cholesterol levels.

A number of studies have also associated higher intakes of vitamin C with decreased incidence of cancers of the upper digestive tract, cervix, ovary, bladder, and colon. A cow's milk liquid beverage comprising cow's milk and externally added vitamin C according to the invention may thus decrease incidence of cancers.

Additional potential beneficial uses of vitamin C include: benefit in terms of the duration and severity of episodes of common cold; wound healing, prevention of infections and promotion of skin repair during a postoperative period; and improved dilation of blood vessels and lowering of blood pressure. Drinking a cow's milk liquid beverage according to the invention comprising externally added vitamin C may thus be beneficial for these particular indications.

### Omega-3 (DHA)

It is known that infants who are not breast fed are the most prominent group likely to be deficient in DHA. Omega-3 are also known to be important in adults and symptoms associated with a Omega-3 deficiency are reported to include poor neurological development, decreased concentration, dementia, depression, esp. postpartum depression, dyslexia, low serotonin levels, memory loss, and visual problems. A cow's milk liquid beverage according to the invention comprising cow's milk and externally added omega-3 (e.g. DHA) may thus have potential therapeutic uses for addressing these deficiencies and/or in the prevention and/or treatment of Alzheimer's disease, attention deficit disorder (ADD), high triglycerides, hyperactivity, learning disorders, neurological and visual development in infants.

### Lactoferrin

Lactoferrin is an iron-binding glycoprotein found in human milk in a greater concentration that in cow's milk. Its biological role has not been fully established but it is generally considered to act as a bacteriostatic agent by sequestering iron from iron-requiring bacteria. It is also suggested that it might promote iron absorption. On a protein basis, whey from bovine milk contains more lactoferrin than cow's milk. Therefore drinking a cow's milk liquid beverage with adjusted protein concentration and protein ratio according to the invention may thus be beneficial to individuals, for instance to increase lactoferrin levels in the body or to promote iron absorption.

### EXAMPLES

### Example 1

### Process for Making Liquid and Protein-Rebalanced Cow's Milk According to a First Embodiment of the Invention (FIG. 1)

### Milk Ultra-Filtrated (UF) Permeate Preparation

Whole milk 2 (raw or pasteurised) between 4° C. and 50° C. is skimmed 4 by a centrifugal separator to generate skim milk 6 and cream 8. One hundred kg of fresh skim milk 2 is concentrated to a concentration factor of 3× generating 33 kg of retentate 12 rich in proteins and 67 kg of permeate 10 containing water, lactose, soluble minerals and nitrogenous fractions (urea, proteose, peptones and others). The concentration 13 is done in a batch mode in close loop configuration using hollow fiber membrane of 10 000 Da molecular weight cut-off operated at 50° C. The permeate 10 is then cooled until further use and the retentate 12 can be used in cheese making, yogurt production or other dairy product.

### Formulation of the Product

In order to make 100 kg of the desired formulation 1, three main components and are mixed in a double wall agitated tank: 60.1 kg of milk permeate 10, 30.3 kg of milk 2 (3.5% fat) and 8.4 kg of cream 8 (35.0% fat). The resulting mixture is then agitated and heated by circulation of 80° C. water in a jacket until it reaches 50° C.

To obtain the final desired milk formulation 1, other dry ingredients (e.g. 0.87 kg of dry whey protein concentrate (80% protein) and 40 g of acerola cherry powder) are added to mixture and dispersed by agitation.

### Processing

In order to improve the homogeneity of the formulation 1 prior its sterilization, the formulation 1 is homogenized 22 between 4° and 50° C. at low pressure using a standard double valve homogenizer (100 psi/500 psi). The homogeneous dispersion is then heat treated 24 in an indirect heating UHT system (142° C., 4 sec) to ensure bacterial destruction, partially cooled to 70° C. for homogenization 26 (500 psi/2500 psi) followed by final cooling and packaging 28 (e.g. aseptic container, plastic jugs or bottles, gable top cardboard, polyethylene pouch, etc.). The packaged product can be stored 30 (at room temperature or in a cold room, as more appropriate) until its distribution 32.

The milk beverage so obtained after the homogenization 26 and cooling steps was then analyzed and its properties were compared to breast milk and cow's milk as shown in Table 3.

### Example 2

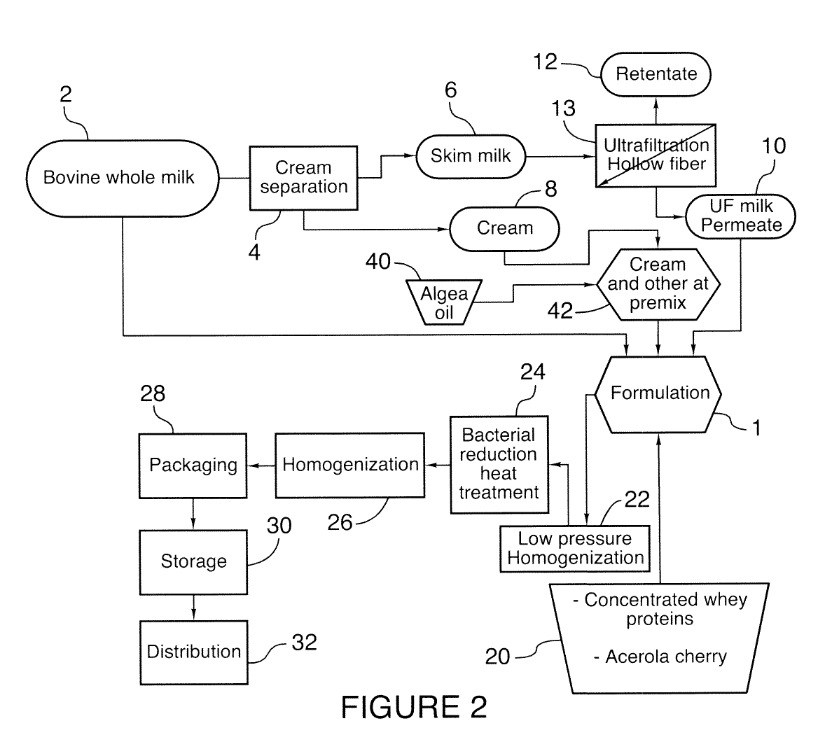

### Process for Making Liquid and Protein-Rebalanced Cow's Milk According to a Second Embodiment of the Invention (FIG. 2)

### Milk Ultra-Filtrated (UF) Permeate Preparation

That step is carried out according to the procedure described in Example 1.

### Preparation of the Cream and Other Fat Sources Premix

According to this Example, DHA rich algae oil 40 is added to the formulation 1. In order to prevent PUFA oxidation of the DHA rich algae oil, the oil 40 is dispersed in the cream 8: 0.25 kg of algae oil 40 is added to 8.4 kg of cream 8 (35% fat) and slowly stirred until well dispersed to obtain a cream premix 32.

### Formulation

In order to make 100 kg of the desired milk formulation 1, two main components are first mixed in an double wall agitated tank: 60.1 kg of milk permeate 10 and 30.3 kg of milk 2 (3.5% fat). The cream 8 and DHA rich algae oil premix 42 are next added to the tank. The resulting mixture is then agitated and heated by circulation of 80° C. water in a jacket until it reaches 50° C.

To obtain the final desired milk formulation 1, other dry ingredients (e.g. 0.87 kg of dry whey protein concentrate (80% protein) and 40 g of acerola cherry powder) are added to mixture and dispersed by agitation.

### Processing

That step is carried out according to the procedure described in Example 1.

### Example 3

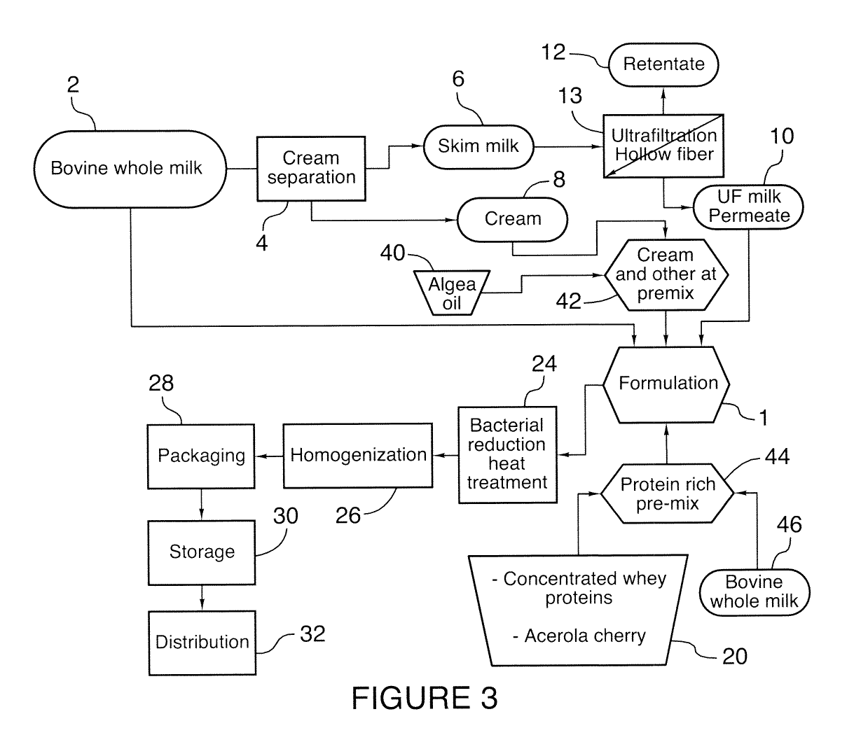

### Process for Making Liquid and Protein-Rebalanced Cow's Milk According to a Third Embodiment of the Invention (FIG. 3)

### Milk Ultra-Filtrated (UF) Preparation

That step is carried out according to the procedure described in Example 1.

### Preparation of the Cream and Other Fat Sources Premix

That step is carried out according to the procedure described in Example 2.

### Preparation of the Protein Rich Pre-Mix

According to this Example, to facilitate the dispersion of dry powders to be part of the formulation 1, the WPC 80 powder and the acerola cherry powder are hydrated in milk prior their addition. Briefly, 15 kg of milk 46 (3.5% fat) is heated to 50° C. in a double wall stirred tank. The WPC 80 powder (0.87 kg) and the acerola cherry powder (40 g) are then added 20 and vigorously stirred until well dispersed to obtain a protein-rich premix 44.

### Formulation

In order to make 100 kg of the desired milk formulation 1, two main components are mixed in an double wall agitated tank: 60.1 kg of milk permeate 10 and the remaining of the milk 2 (15.3 kg at 3.5% fat). The cream premix 32 comprising the cream 8 and DHA rich algae oil 40 is next added to the tank. The protein-rich premix 44 is also added to the thank. The final desired milk formulation 1 is then agitated and heated by circulation of 80° C. water in the jacket until it reaches 50° C.

### Processing

That step is carried out according to the procedure described in Example 1.

### Example 4

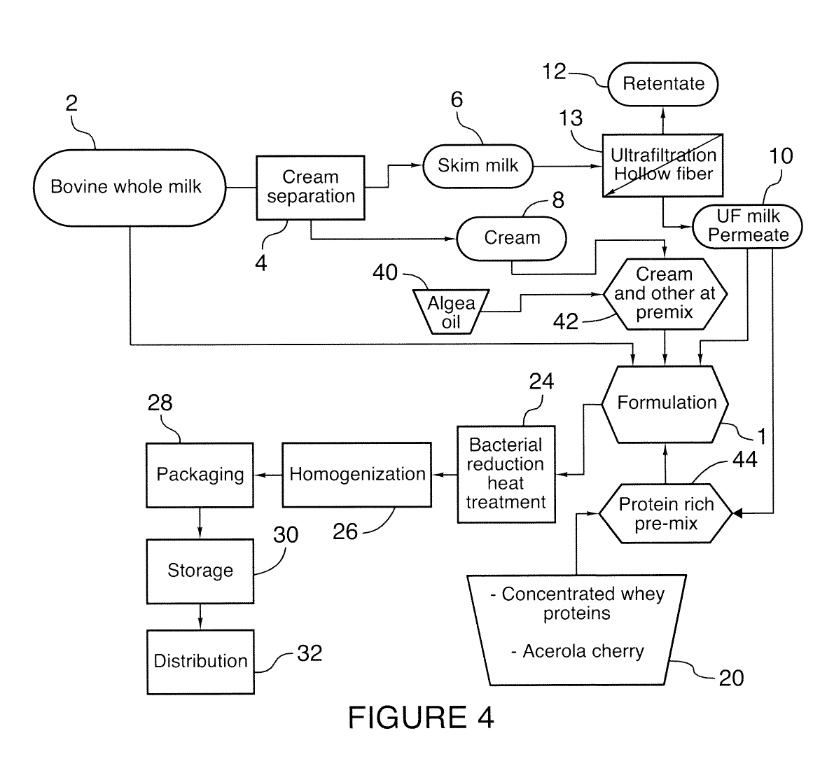

### Process for Making Liquid and Protein-Rebalanced Cow's Milk According to a Forth Embodiment of the Invention (FIG. 4)

### Milk Ultra-Filtrated (UF) Permeate Preparation

That step is carried out according to the procedure described in Example 1.

### Preparation of the Cream and Other Fat Sources Premix

That step is carried out according to the procedure described in Example 2.

### Preparation of the Protein Rich Pre-Mix

According to that Example, another way to facilitate the dispersion of dry powders to be part of the formulation 1, is to disperse the powdered ingredients in a portion of the milk UF permeate 10 prior their incorporation to the formulation 1. For instance, 15 kg of milk UF permeate 10 is heated to 50° C. in a double wall stirred tank. The WPC 80 powder (0.87 kg) and the acerola cherry powder (40 g) are then added 20 and vigorously stirred until well dispersed to obtain a protein-rich pre-mix 44.

### Formulation

That step is carried out according to the procedure described in Example 3.

### Processing

That step is carried out according to the procedure described in Example 1.

### Example 5

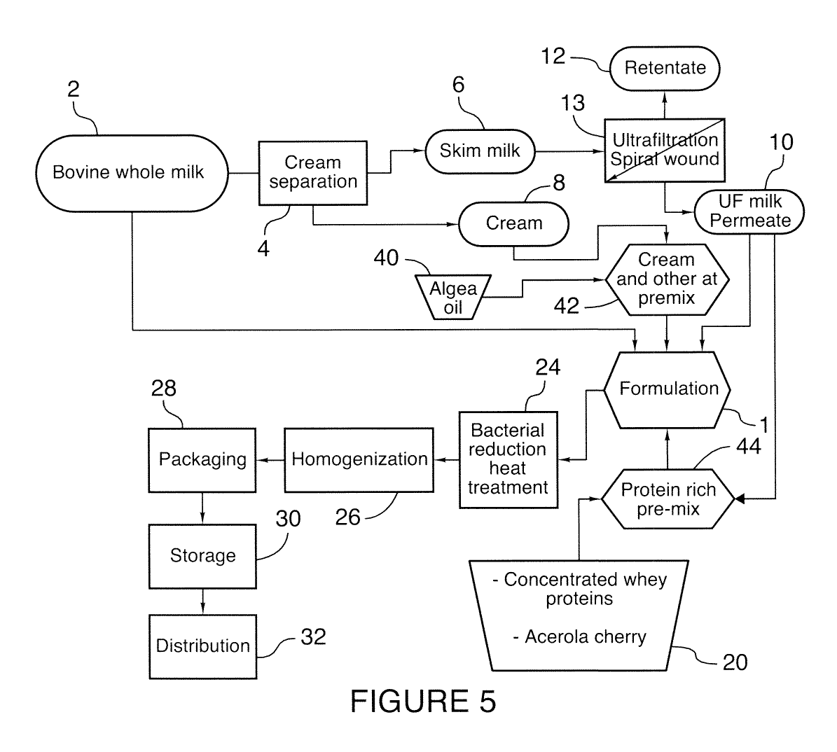

### Process for Making Liquid and Protein-Rebalanced Cow's Milk According to a Fifth Embodiment of the Invention (FIG. 5)

### Milk Ultra-Filtrated (UF) Preparation

Whole milk 2 (raw or pasteurized) between 4° C. and 50° C. is skimmed 4 by a centrifugal separator to generate skim milk 6 and cream 8. According to that Example, another way of obtaining the necessary milk UF permeate 10 is to concentrate 100 kg of fresh skim milk 2 (e.g. raw or pasteurised) to a factor of 3× generating 33 kg of retentate rich in proteins and 67 kg of permeate containing water, lactose, soluble minerals and nitrogenous fractions (urea, proteose peptones and others). The concentration is done in a batch mode in close loop configuration using a spiral wound UF membrane system 33. The membrane has a 10 000 Da molecular weight cut-off and the filtration is operated between 5 and 10° C. The permeate 10 is then stored until further use and the retentate 12 can be used in cheese making, yogurt production or other dairy product.

### Preparation of the Cream and Other Fat Sources Premix

That step is carried out according to the procedure described in Example 2.

### Preparation of the Protein Rich Pre-Mix

That step is carried out according to the procedure described in Example 4.

### Formulation

That step is carried out according to the procedure described in Example 4.

### Processing

That step is carried out according to the procedure described in Example 1.

TABLE 1
Infant formulas composition compared to breast milk (source: Danone Institute).
STARTER INFANT FORMULAS

| | | FORMULAS | | | |
|---|---|---|---|---|---|
| | Breast | Adapted Protein content | | Unchanged Protein content | |
| Per 100 ml | milk | Infant Formulas | | Infant Formulas | |
| Powder (g) | Liquid | 12.7 to 14 | (M: 13.3) | 12.6 to 15 | (M: 13.7) |
| Calories (kcal) | 68 | 66 to 73 | (M: 68.5) | 66 to 72 | (M: 69) |
| Protein (g) | 1.2 | 1.5 to 1.8 | (M: 1.65) | 1.6 to 1.9 | (M: 1.8) |
| Casein (%) | 40 | 44 to 50 | | 60 to 80 | |
| Lipids (g) | 3.5 | 3.2 to 3.7 | (M: 3.6) | 2.6 to 3.8 | (M: 3.3) |
| Linoleic acid (mg) | 350 | 370 to 670 | (M: 520) | 350 to 740 | (M: 525) |
| Linolenic | 37 | 30 to 70 | (M: 50) | 30 to 100 | (M: 55) |
| acid (mg) | | | | | |
| Carbohydrates (g) | 7.5 | 6.7 to 7.9 | (M: 7.4) | 6.8 to 9.5 | (M: 7.9) |
| Lactose (%) | 85 | 71 to 100 | (M: 77) | 47 to 76.5 | (M: 73) |
| Malto-dexterin (g) | 0 | 1.1 to 1.9 | (M: 1.7) | 1.8 to 2.6 | (M: 2.1) |
| Other sugars * | Oligosac- | 0 | | Starch: Gui. C. PEL and Gal. Pre ** | |
| | charides | | | Sucrose LEM and PEL | |
| Minerals (mg) | 210 | 250 to 400 | (M: 315) | 250 to 500 | (M: 400) |
| Sodium (mg) | 16 | 16 to 20 | (M: 17.5) | 16 to 28 | (M: 23) |
| Calcium (mg) | 33 | 43 to 75 | (M: 54.5) | 50 to 93 | (M: 70) |
| Ca/P | 2 | 1.4 to 2 | (M: 1.7) | 1.2 to 1.9 | (M: 1.4) |
| Iron (mg) | 0.05 | 0.01 to 0.8 | (M: 0.8) | 0.7 to 1 | (M: 0.8) |

M = mean
* only lactose and malto-dextrin only
** Gui C: GUIGOZ CONFORT ™; PEL; PELARGON ™; LEM: LEMIEL ™; Gal Pre:GALLIA PREMIUM ™

TABLE 2
Follow-up formulas compared to breast milk after 1 year (source: Danone Institute).
FOLLOW-UP FORMULAS

| | | FORMULAS | | | |
|---|---|---|---|---|---|
| | Breast milk | Weaning follow-up | | Unchanged Protein content | |
| Per 100 ml | (after 1 year) | formulas | | Infant Formulas | |
| Powder (g) | Liquid | 13 to 16 | (M: 14.7) | Liquids (except MATERNA) | |
| Calories (kcal) | 65 | 63 to 76 | (M: 71) | 63 to 71 | (M: 66) |
| Protein (g) | 3.7 | 2 to 3 | (M: 2.3) | 2.2 to 3.2 | (M: 2.6) |
| Casein (%) | 80 | 80 | | 80 | |
| Lipids (g) | 3.5 | 2.5 to 3.6 | (M: 3.1) | 2.4 to 3.5 | (M: 2.8) |
| Linoleic acid (mg) | 90 | 400 to 690 | (M: 515) | 210 to 540 | (M: 390) |
| Linolenic acid (mg) | traces | 39 to 90 | (M: 52) | 38 to 100 | (M: 58) |
| Carbohydrates (g) | 4.5 | 6.2 to 9.1 | (M: 8.1) | 5.5 to 8.1 | (M: 7.6) |
| Lactose (%) | 100 | 42 to 88 | | 41 to 100 | |
| Malto-dexterin (g) | 0 | 0.7 to 4.9 | (M: 2.3) | 0 to 3.2 | (M: 1) |
| Other sugars * | 0 | Starch: Gui. C. LEM *. | | Starch: Mil * | |
| | | Sucrose. Fructose. | | Sucrose: Gui. C. Nest * | |
| | | Glucose: LEM * | | | |
| Minerals (mg) | 800 | 500 to 680 | (M: 550) | 520 to 800 | (M: 670) |
| Sodium (mg) | 48 | 19 to 43 | (M: 33) | 32 to 42 | (M: 37) |
| Calcium (mg) | 125 | 80 to 108 | (M: 88) | 95 to 111 | (M: 102) |
| Ca/P | 1.25 | 1.17 to 1.7 | (M: 1.3) | 1.2 to 1.57 | (M: 1.3) |
| Iron (mg) | 0.03 | 0.8 to 1.4 | (M: 1.2) | 1 to 1.4 | (M: 1.2) |

M = mean
* Gui C: GUIGOZ CONFORT ™; LEM: LEMIEL ™; Nest: NESTLE JUNIOR ™; Gui PP: GUIGOZ Premier pas ™; Mil: MILUPA CROISSANCE ™

TABLE 3
Milk beverage according to the one embodiment of the
invention compared to breast milk and cow's milk.

| Nutrients | | Breast | Cow's milk | Milk beverage |
|---|---|---|---|---|
| (100 g) | Units | milk | (3.25% fat) | of Example 1 |
| Calories | Kcal | 73.20 | 63.20 | 63.68 |
| Proteins | g | 1.10 | 3.40 | 2.00 |
| Carbohydrates | g | 7.20 | 4.80 | 4.77 |
| Total fat | | 4.60 | 3.40 | 4.00 |
| Saturated | g | 2.10 | 2.10 | 2.44 |
| Monounsaturated | g | 1.70 | 0.90 | 0.88 |
| Polyunsaturated | g | 0.50 | 0.10 | 0.17 |
| 18:3 ALA omega-3 | g | 0.10 | 0.00 | 0.00 |
| 18:2 AL omega-6 | g | 0.40 | 0.10 | 0.03 |
| 22:6 DHA omega-3 | g | 0.00 | 0.00 | 0.01 |
| 20:5 EPA omega-3 | g | 0.00 | 0.00 | 0.00 |
| Cholesterol | mg | 14.00 | 14.0 | 13.24 |
| Minerals | | | | |
| Calcium | mg | 33.00 | 83.20 | 66.00 |
| Iron | mg | 0.03 | 0.05 | 0.03 |
| Magnesium | mg | 4.00 | 1.50 | 4.84 |
| Phosphorus | mg | 14.00 | 88.00 | 54.99 |
| Potassium | mg | 53.00 | 156.00 | 153.41 |
| Sodium | mg | 18.00 | 51.20 | 42.49 |
| Zinc | mg | 0.18 | 0.39 | 0.13 |
| Copper | mg | 50.00 | 10.00 | 3.03 |
| Manganese | mg | 0.03 | 0.00 | 0.00 |
| Selenium | μg | 2.00 | 2.00 | 0.61 |
| Vitamin C | mg | 5.00 | 1.00 | 2.00 |
| Thiamine | mg | 0.01 | 0.04 | 0.01 |
| Riboflavin | mg | 0.04 | 0.17 | 0.14 |
| Niacin | mg | 0.50 | 0.90 | 0.28 |
| Pantothenic acid | mg | 0.23 | 0.32 | 0.08 |
| Vitamin B6 | mg | 0.01 | 0.04 | 0.01 |
| Folate | μg | 5.00 | 5.00 | 1.60 |
| Vitamin B12 | μg | 0.00 | 0.40 | 0.11 |
| Vitamin A | μg-EAR | 64.00 | 31.20 | 45.94 |
| Vitamin E | mg-EAT | 0.94 | 0.10 | 0.13 |
| Vitamin D | μg | 0.10 | 1.14 | 0.86 |

Headings are included herein for reference and to aid in locating certain sections These headings are not intended to limit the scope of the concepts described therein under, and these concepts may have applicability in other sections throughout the entire specification. Thus, the present invention is not intended to be limited to the embodiments shown herein but is to be accorded the widest scope consistent with the principles and novel features disclosed herein.

Although throughout this document reference is made to cow's milk, the invention is not limited to cow's milk only. Indeed, the principles of the invention are applicable to milk from other mammals including but not limited to goat, buffalo, ewe and camel. Accordingly, the invention encompasses protein-rebalanced goat's milk, protein-rebalanced ewe's milk protein-rebalanced camel's milk and protein-rebalanced buffalo's milk. The invention also encompasses goat's milk, ewe's milk and buffalo's milk comprising externally added ingredients as described herein, and more particularity such milk comprising vitamin C and/or comprising an acerola berries extract.

As used herein and in the appended claims, the singular forms “a”, “an”, and “the” include plural referents unless the context clearly indicates otherwise. Thus, for example, reference to “an ingredient” includes one or more of such compounds, and reference to “the method” or “the process” includes reference to equivalent steps and methods known to those of ordinary skill in the art that could be modified or substituted for the methods and processes described herein. Similarly, reference to “toddlers” (plural) encompasses a plurality or a single individual toddler.

It is understood that the examples and embodiments described herein are for illustrative purposes only and that various modifications or changes in light thereof will be suggested to persons skilled in the art and are to be included within the present invention and scope of the appended claims.

1. A liquid milk beverage for toddlers comprising non-hydrolyzed, non-fermented and protein-rebalanced cow's milk, wherein said non-hydrolyzed, non-fermented and protein-rebalanced cow's milk comprises a reduced weight/weight proportion of casein:whey proteins when compared to untreated cow's milk.

2. The liquid milk beverage of claim 1, wherein the proportion of casein:whey proteins is equal to or lower than about 70:30.

3. The liquid milk beverage of claim 1, wherein the proportion of casein:whey proteins is equal to or lower than about 40:60.

4. The liquid milk beverage of claim 1, wherein said reduced proportion of casein:whey proteins facilitates digestion of the cow's liquid milk beverage by toddlers.

5. The liquid milk beverage of claim 1, wherein said liquid milk beverage comprises a reduced total protein concentration when compared to untreated cow's milk.

6. The liquid milk beverage of claim 1, wherein said liquid milk beverage further comprises externally added omega-3.

7. The liquid milk beverage of claim 1, wherein said liquid milk beverage further comprises externally added vitamin C.

8. The liquid milk beverage of claim 1, wherein said liquid milk beverage further comprises an extract of acerola berries.

9. The liquid milk beverage of claim 1, wherein said liquid milk beverage further comprises externally added ingredients selected from the group consisting of vitamins, prebiotics probiotic, fibers, minerals, oil, essential fatty acids, antioxidants, biologically active peptides, and combinations thereof.

10. The liquid milk beverage of claim 1, wherein said non-hydrolyzed, non-fermented and protein-rebalanced cow's milk comprises fresh ultra-filtrated cow's milk.

11. The liquid milk beverage of claim 1, wherein said liquid milk beverage has been pasteurized by a Ultra High Temperature (UHT) process.

12. A cow's milk liquid beverage for toddlers comprising cow's milk and externally added vitamin C.

13. The cow's milk liquid beverage of claim 12, wherein said cow's milk liquid beverage comprises about 0.5 mg/100 ml to about 4 mg/100 ml vitamin C.

14. The cow's milk liquid beverage of claim 12, wherein said cow's milk liquid beverage comprises about about 2 mg/ml vitamin C.

15. The cow's milk liquid beverage of claim 12, wherein said externally added vitamin C is from acerola berries.

16. A liquid cow's milk beverage, comprising:
fresh ultra-filtrated and Ultra High Temperature (UHT) pasteurized cow's milk, wherein said milk has been protein-rebalanced for having a weight/weight proportion of casein:whey proteins equal to or lower than about 50:50;
externally added algal oil; and
externally added juice of acerola berries.

17. The liquid cow's milk beverage of claim 16, wherein said beverage further comprises externally added ingredients selected from the group consisting of vitamins, prebiotics probiotic, fibers, minerals, oil, essential fatty acids, antioxidants, biologically active peptides, and combinations thereof.

18. A method for providing nutrition to a toddler of about 10 to about 36 months of age, comprising feeding said toddler with a liquid milk beverage as defined in claim 1.

19. A method for facilitating transition from breast feeding and/or artificial formula feeding of a child towards drinking of cow's homogenized milk, comprising: (i) providing a cow's milk liquid beverage as defined in claim 1; and (ii) incorporating to the child's diet increasing quantity of said cow's milk liquid beverage.

20. The method of claim 19, further comprising incorporating to the child's diet increasing quantity of cow's homogenized milk.

21. The method of claim 19, wherein said liquid milk beverage is mixed gradually with cereals.

22. A method for increasing digestion of cow's milk in an individual, comprising: (1) rebalancing proteins content of liquid cow's milk to provide a liquid non-hydrolyzed, non-fermented rebalanced cow's milk having a reduced proportion of casein:whey proteins when compared to untreated liquid cow's milk, wherein said reduced weight/weight proportion of casein:whey proteins is equal to or lower than about 50:50; and (2) feeding said individual with said liquid non-hydrolyzed, non-fermented rebalanced cow's milk.

23. A process for making fresh liquid and protein rebalanced cow's milk having a reduced weight/weight proportion of casein:whey proteins when compared to untreated fresh liquid cow's milk, the process comprising mixing in suitable quantities a milk permeate, cream and fresh liquid cow's milk in order to obtain a fresh liquid and protein-rebalanced cow's milk having a desired lipid, mineral and water content and a having a desired reduced weight/weight proportion of casein:whey proteins.

24. The process of claim 23, wherein the reduced weight/weight proportion of casein:whey proteins is equal to or lower than about 70:30.

25. The process of claim 24, wherein the reduced proportion of casein:whey proteins is equal to or lower than about 40:60.
